(19) United States
(12) Patent Application Publication
(10) Pub. No.: US 2007/0266263 A1
(43) Pub. Date: Nov. 15, 2007

(54) Speed adjustment system and method for performing the same

(75) Inventors: Ming-hsien Lee, Hsinchu City (TW); Jen-pin Su, Hsinchu City (TW); Tsan-hwi Chen, Hsinchu City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Silicon Integrated Systems Corp.

(21) Appl. No.: 11/432,783

(22) Filed: May 11, 2006

(51) Int. Cl. G06F 1/00

(52) U.S. Cl. 713/300

(57) ABSTRACT

The present invention discloses a speed adjustment system and method for performing the same, which is capable to provide different power saving behaviors adaptive for different applications (e.g. a mobile or a normal configuration) and/or different-corner-process chips. The speed adjustment system includes a reference speed generator for pre-storing multiple reference speed value, an operating speed generator for pre-storing multiple operating speed value, a comparing unit for determining whether a predefined logical operational relationship is satisfied with the operating speed value and reference speed value, a voltage controller based on said determination result to vary the operating voltage, and a speed detector for detecting the operating speed value.

### BACKGROUND OF INVENTION

The present invention relates to a speed adjustment system and method for performing the same, and particularly in an adjustable chip-speed system, which depends upon various applications of an integrated chip to determine adaptive power saving behaviors.

### DESCRIPTION OF THE PRIOR ART

Generally speaking, the power consumption amount is typically deemed one of the performance indexes for a variety of electrical systems, for example, 3 C (communication, computing, and consumptive) products. An overhigh power consumption is harmful to the heat dissipation, reliability and durability of the electrical system. Therefore, it is a significant topic for the manufacturers to establish a power saving configuration.

As well known in the art, the power consumption amount may be frequently varied upon both a power supply management and a system operating speed (i.e. an operating frequency) of the electrical system (like an IC chip). For an oscillator in support of synchronous operations of the electrical system, an operating frequency output from the oscillator is further considered proportional to the power (or core) voltage that is supplied to the oscillator. This brings a way to adjustably increase/decrease the output frequency based on a difference from a fixed reference frequency to raise up/drop down the power supply voltage in levels.

As well known in the art, the same-model electrical systems, i.e. IC chips, respectively applied in different configurations might have the same power consumption behaviors, even under different system clock speeds that are actually required for the different configurations. For example, a standardized chip, which can operate for a normal configuration (e.g. a personal computer) at a maximum system clock frequency of up to 500 MHz under a specific voltage supply of 1.2 V, is selectively used for a mobile configuration (e.g. a mobile phone) at a chip operating speed of only 400 MHz enough to keep the mobile configuration stably running, needless to reach a speed of 500 MHz. This causes a waste on the power (i.e. under a voltage supply of 1.2 V) capable of achieving the maximum clock speed of 500 MHz, which is consumed to perform the clock speed of approximate 400 MHz. Beside, the power saving behaviors adapted by the same-type chips applied for the different configurations are kept the same as each other. Therefore, the conventional electrical system is unable to provide different configurations with selectable adaptive power saving behaviors.

Furthermore, as well known in the art, fabricating the same-type IC chips under different process speeds would deeply reflect the performance efficiency of these IC chips.

During an identical wafer fabrication process, different level yields of the chips can be distributively depicted on different comers of a statistical chart as a Gaussian Distributions. Most of the chips gather on a Typical-N and Typical-P (TT) corner, and less chips respectively spread on a Fast-N and Fast-P (FF) corner, a Fast-N and Slow-P (FS) corner, a Slow-N and Fast-P (SF) corner or a Slow-N and Slow-P (SS) corner. Under supply of the same power voltage (i.e. 1.2 V), the SS-corner chips inherently operate at a slower speed than the other chips allocated out of the SS corner of the same process, and the FF-corner chips inherently operate at a faster speed than the other chips allocated out of the FF corner of the same process. Nevertheless, yields of these different-corner chips all should be qualified and the chip structures are the same. The difference-corner chips still have the same power saving behaviors, rather than the respective adaptive power saving behaviors. This would result in a power waste for the different-corner chips.

### SUMMARY OF INVENTION

To address the foregoing drawbacks of the prior technology, it is a primary object of the present invention to provide a speed adjustment system and method for performing the same, which determines adaptive power saving behaviors of the electrical system (e.g. an integrated chip) applied for different applications (e.g. a mobile phone, a monitor, a desktop or laptop computer).

It is a secondary object of the present invention to provide a speed adjustment system and method for performing the same, which depends upon different process-speed (so-called “different-corner”) chips to determine the respective adaptive power saving behaviors for the different process-speed chips.

It is another object of the present invention to provide a speed adjustment system and method for performing the same, which depends upon different conditions, e.g. a chip temperature difference, a power consumption mode or a manual order, to determine adaptive power saving behaviors for the same-type chips.

In a first embodiment, the speed adjustment system applied for an electrical system (i.e. a standalone chip) could be used for different applications like a mobile configuration or a computerized configuration, and includes a reference speed generator having a register for pre-storing multiple reference speed values, an operating speed generator having a register for pre-storing multiple operating speed value, a comparing unit for determining whether a predefined logical operational relationship that the operating speed value is identical with or smaller than the reference speed value is satisfied, a voltage controller based on said determination result to determine which logic level of the operating voltage is fed to the speed detector, a voltage-dependent oscillators unit based on the operating voltage supplied to the electrical system to generate multiple operating frequencies which serve as multiple operating speed values and a speed detector for detecting the operating speed value and pre-storing the operating speed values in the operating speed generator as registered.

In a second embodiment, the speed adjustment system further a speed scaling calculator for calculating a speed scaling value of the operating speed value with relation to the reference speed value, and a speed scaling range generator for pre-storing multiple speed scaling ranges, in comparison with the first embodiment. Thus, the comparing unit is operative to determine whether a predefined logical operational relationship that the speed scaling value is in the preset speed scaling range is satisfied or not. Accordingly, the operating speed and voltage supply for the operating chip will be continuously adjusted (raised/lowered) until the predefined logical operational relationship is satisfied to achieve a selected power saving behavior.

Besides, a method for adjusting an operating speed of an electrical system, comprising the steps of:

pre-storing multiple reference speed values;

respectively detecting multiple operating speed values generated relative to an operating voltage supplied to the electrical system;

pre-storing multiple operating speed values;

determining whether or not a predefined logical operational relationship between the operating speed value and the reference speed value is satisfied; and

keeping logic level of the operating voltage unchanged if the predefined logical operational relationship is satisfied; otherwise, adjusting the logic level of the operating voltage until the predefined logical operational relationship is satisfied.

### BRIEF DESCRIPTION OF DRAWINGS

FIG. 1 illustrates a schematic architecture diagram of a speed adjustment system according to a first embodiment of the present invention;

FIG. 2 illustrates a schematic architecture diagram of a speed adjustment system according to a second embodiment of the present invention;

FIG. 3A illustrates a schematic device diagram regarding to a kind of voltage controller applied for the speed adjustment according to the present invention;

FIG. 3B illustrates a schematic device diagram regarding to another kind of voltage controller applied for the speed adjustment according to the present invention;

FIG. 4 illustrates a schematic device diagram regarding to a reference speed generator applied in the speed adjustment system;

FIG. 5A illustrates a flow chart of a method for adjusting an operation speed of a chip according to the present invention;

FIG. 5B illustrates a flow chart of another method for adjusting an operation speed of an integrated chip according to the present invention;

FIG. 6 illustrates a schematic diagram regarding to a speed detector of the speed adjustment system; and

FIG. 7 illustrates a flow chart of a method of detecting an operation frequency from each of the selected ROSC sets according to the present invention.

### DETAILED DESCRIPTION

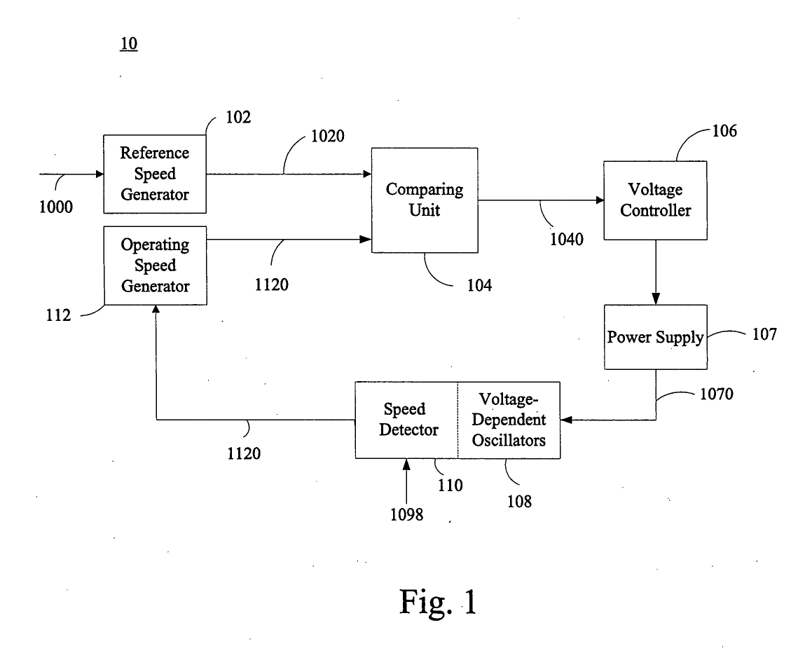

Please refer to a schematic architecture diagram of a speed adjustment system 10 presented in FIG. 1 according to a first preferred embodiment of the present invention. The speed adjustment system 10 can be applied for an electrical system that is constructed in a standalone chip or an integral circuitry system. The electrical system could be adequate for different configurations, such as a mobile configuration (e.g. a mobile phone or a PDA), a computerized configuration (e.g. a personal computer), and so on. The speed adjustment system 10 is configured with a reference speed generator 102, a comparing unit 104, a voltage controller 106, a voltage-dependent oscillators unit 108, a speed detector 110, and an operating speed generator 112.

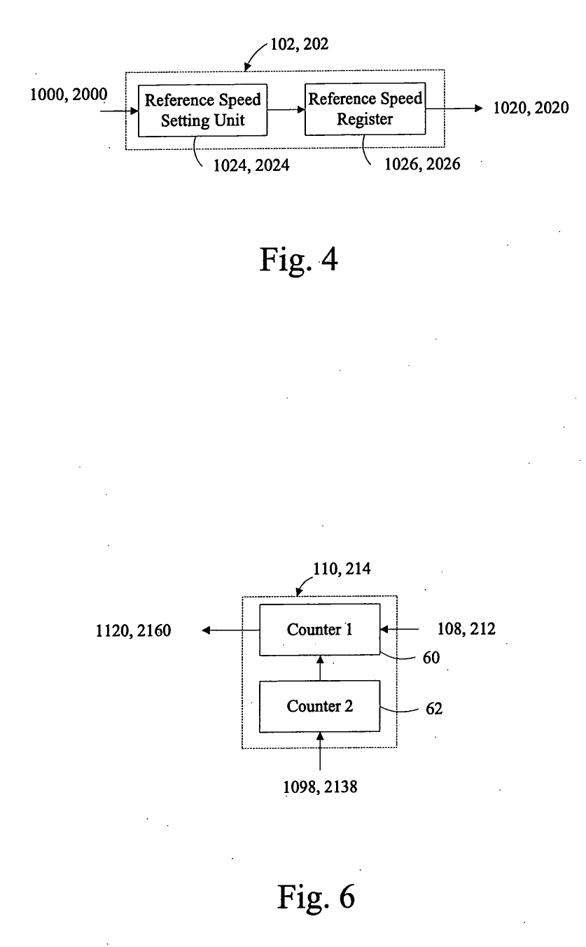

The reference speed generator 102 as shown in FIG. 4 further includes a reference speed setting unit 1024 and a reference speed register 1026. The reference speed setting unit 1024 depends upon a voltage setting signal 1000 from a manual or an initial configuration to pre-set multiple different reference speed values on the reference speed register 1026. These multiple different reference speed values are respectively predetermined for different configurations and/or different-corner chips. For an exemplary of a process-driven voltage control on the same-type and different-corner chips for the same configurations, a first reference speed value representative of a lowest speed is predetermined in accordance with an operating frequency (i.e. 380 MHz) employed by a sampled slow-slow (SS) corner chip under a specific voltage supply (i.e. a minimum workable voltage) or a standard voltage supply (i.e. 1.2 V), and a second reference speed value representative of a medium speed is predetermined in accordance with an operating frequency (i.e. 400 MHz) employed by a sampled Typical-Typical (TT) corner chip under the same voltage supply, and a third reference speed value representative of a fastest speed is predetermined in accordance with an operating frequency (i.e. 420 MHz) employed by a sampled fast-fast (FF) corner chip under the same voltage supply.

For another exemplary of a frequency-driven voltage control on the same-type chips for different configurations, a first reference speed value representative of a lowest speed is predetermined in accordance with an operating frequency (i.e. 350 MHz) of the chip enough to support a stable operation of a mobile configuration under a specific voltage supply (i.e. a minimum workable voltage) or a standard voltage supply (i.e. 1.2 V), and a second reference speed value representative of a faster speed is predetermined in accordance with an operating frequency (i.e. 400 MHz) employed by the same-type chip applied for a normal configuration (i.e. PC) under the same voltage supply.

For another exemplary of combination of a frequency-driven and process-driven voltage controls on the same-type and different-corner chips for different configurations, a first speed frequency value representative of a lowest speed is predetermined in accordance with an operating frequency (i.e. 350 MHz) adopted by the SS-corner chip applied for the mobile configuration under a specific voltage supply (i.e. a minimum workable voltage) or a standard voltage supply (i.e. 1.2 V). It is noted that said sampled different-corner chips have the same structures as the electrical system of the present invention under the same fabrication process.

The first embodiment of the present invention will be introduced on utilization of an operating frequency of a sampled SS-corner chip to be as a reference speed value since the SS-corner chip is lower than other corners chip in operating speed, but does not therefore limit the scope of the invention. As well known, an operating frequency adapted by the chip can be regarded as correspondence to the operating speed of the chip. Understandingly, the other corners chips (i.e. a FF corner chip) will consume a higher power than the SS-corner chip does if operating at the same speed under the same configuration. Consequently, the operating speed of the electrical system of the present invention can be reduced with reference to the operating frequency of the sampled SS-corner chip, resulting in reduction of a voltage supply to achieve the lower power consumption.

In other implementation, the specific voltage supply (Ivdd) for the sampled chip (i.e. a SS-corner chip) may be determined by an equation (1) as follows.
Ivdd=1.2V-Delta (1)

The voltage value of 1.2V denotes an exemplar standard voltage supplied to the sampled SS-corner chip but is not used to limit a scope claimed in the present invention. The “Delta” value represents a minimum voltage gap between a first minimum workable voltage applied in a first configuration (e.g. a normal application) and a second minimum workable voltage applied in a second configuration (e.g. a mobile application) lower than the first minimum workable voltage of the first configuration, under different-corner chips. Since the minimum voltage gap can decide number difference of ring oscillators used on the sampled SS-corner chip, a final reference speed value may be generated lower than a normal speed applied in the SS-corner chip with a normal voltage supply, i.e. 1.2V, by way of subtracting the minimum voltage gap from the normal voltage supply.

Turning to FIGS. 1 and 4, the reference speed generator 102 outputs one of the reference speed values 1020 (i.e. an operating frequency of the sampled SS-corner chip under a specific voltage supply), from its reference speed register 1026 to the comparing unit 104, which can matches an operating speed value output from the operating speed generator 112.

Furthermore, the operating speed generator 112 having an operating speed register is operative to store multiple different operating speed values 1120 thereon, based on different speed conditions, detected from the speed detector 110 and outputs proper one of the operating speed values 1120 to the comparing unit 104.

The comparing unit 104 determines whether a predefined logical operational relationship is accomplished by the operating speed value 1120 and the reference speed value 1020. In the embodiments, the predefined logical operational relationship denotes that the operating speed value 1120 is identical with or smaller than the reference speed value 1020. It also means that the operating speed of the operating chip is identical with or lags behind the reference speed. If the predefined logical operational relationship is satisfied, the comparing unit 104 commands the voltage controller 106 to keep the logic level of an internal operating voltage 1070 unchanged, output from the power supply 107 to the voltage-dependent oscillators unit 108; otherwise to enable the voltage controller 106 to adjust the logic level of the internal operating voltage 1070 output from the power supply 107 to the voltage-dependent oscillators unit 108, based on a difference value determined from the predefined logical operational relationship.

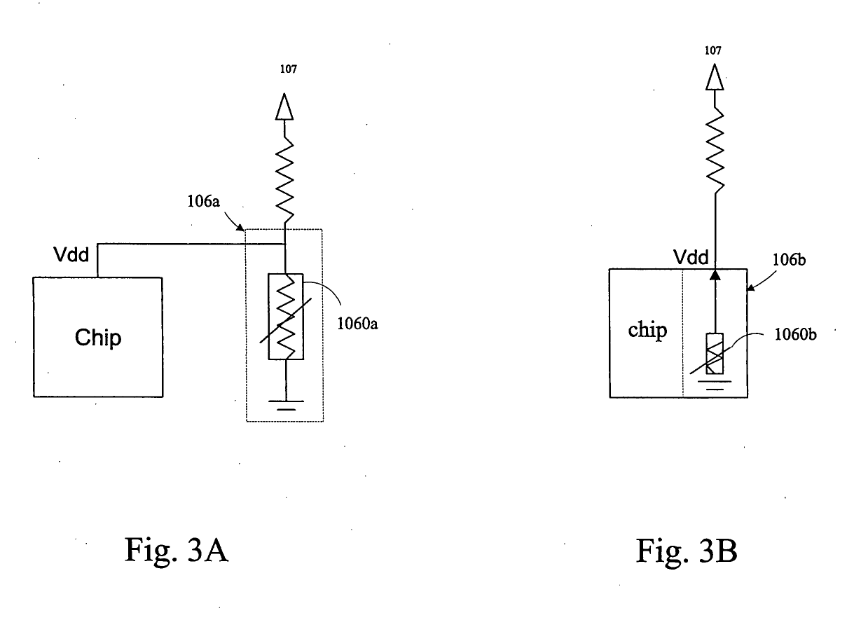

The voltage controller 106 as shown in 3A and 3B has a variable resistor 1060a, 1060b for determining which one logic level of the internal operating voltage (Vdd) 1070 generated from the power supply 107, and a resistance-adjusting unit (not shown) that can be implemented as a software or a hardware, used to adjust resistance of the variable resistor 1060a, 1060b, according to said speed comparison result generated from the comparing unit 104. In an exemplary shown in FIG. 3A, a variable resistor 1060a of a voltage controller 106a (Vdd) is disposed out of the operating chip to vary an internal operating voltage supplied to the operating chip. In another exemplary shown in FIG. 3B, a variable resistor 1060b of another-type voltage controller 106b is disposed inside the operating chip to vary an internal operating voltage supplied to the operating chip. In other exemplary, the voltage controller 106 may be implemented as any other well-known ways to adjust the voltage supply, not limited in usage of the variable resistors 1060a or 1060b.

The voltage-dependent oscillators unit 108 has multiple ring oscillator (ROSC) sets and depends upon the logic level of the varied operating voltage 1070 generated from the power supply 107 to select proper number of the ring oscillator (ROSC) sets for respectively emulating the multiple operating frequencies to be detected by the speed detector 110. The emulated operating frequency can fully reflect an accurate system operating frequency employed by the electrical system (as an integrated chip), thereby steering more adaptive power saving behavior. Please be noted that each selected ring oscillator (ROSC) set may contain one ring oscillator or more than one of the ring oscillators.

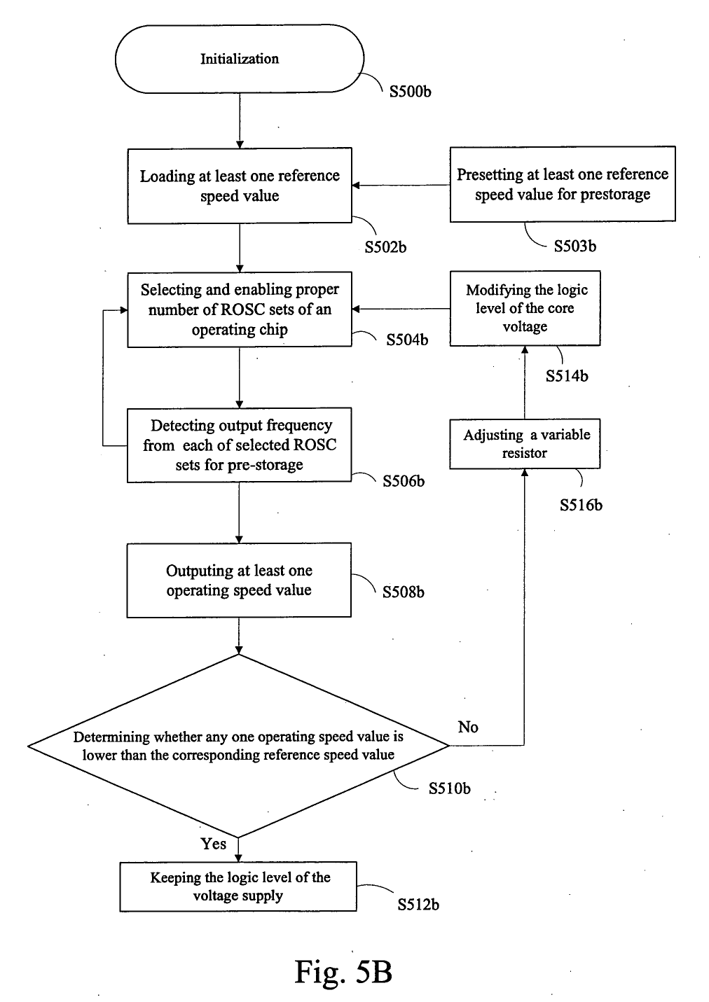

The speed detector 110 as depicted in FIG. 6, includes a first counter 60 and a second counter 62 therein. The second counter 62 employs a calibrating clock signal 1098 having a standard working frequency provided from an external device or other component to count up number of cycles of the calibrating clock signal 1098 for a specific time period. The first counter 110 receives and employs an operating clock signal having an operating frequency generated from the respective selected ROSC set of the voltage-dependent oscillators unit 108 to count up number of cycles of the operating clock signal in synchronization with beginning of counting of the second counter 62 for the same specific time period. Accordingly, the speed detector 110 can detect a corresponding operating frequency resonated from each one of the selected ring oscillator (ROSC) sets. Thereafter the speed detector 110 will store the number value of counted cycles into the operating speed generator 112, indicative of the operating frequency, to serve as an operating speed value 1120 to be placed/updated in the operating speed generator 112 for pre-registering. Then the speed detector 110 further determines whether or not each selected ROSC set has been detected. If so, at least one of the operating speed values 1120 is outputted selectively from the operating speed register 112 to the comparing unit 104, which more approach the reference speed value 1020.

Turning to FIG. 1, a loop that contains the steps of successively modifying the voltage supply to renew the operating speed value 1120 and then comparing the speed values 1020 and 1120 to decide the voltage supply will be established unless said predefined logical operational relationship between both of the speed values 1020 and 1120 is satisfied under determination of the comparing unit 104. Please note that a separation or an integration of both the speed detector 110 and the voltage-dependent oscillators unit 108 belongs to a scope claimed by the present invention.

For an exemplary of the process-driven voltage control on the same-type and different-corner chips for the same configurations, a reference speed value 1020 recorded in the reference speed generator 100 may be predetermined with an operating frequency of 380 MHz steered by a sampled slow-slow (SS) corner chip under a specific voltage supply of 1.2 V. However, an actual operating speed value 1120 (provided from the operating speed generator 112) of the same-type, TT-corner chip that is detected at 400 MHz is higher than the reference speed value 1020 of 380 MHz during the comparison. Under this manner, the voltage controller 106 will be enabled to adjust the variable resistor 1060a or 1060b to lower the logic level of the operating voltage 1070 generated from the power supply 107. Based on the changed operating voltage 1070, the operating speed value 1120 will be lowered and compared with the reference speed value 1020 again to form a loop. By successively adjusting the operating voltage 1070 in each loop, the operating speed value 1120 may be successively renewed from 400 MHz to 380 MHz until the operating speed value 1120 approaches the reference speed value 1020. Thus, a power saving behavior adaptive for the same-type and different-corner chips applied in the same configurations can be selectively achieved.

For another exemplary of the frequency-driven voltage control on the same-type chips for different configurations, the reference speed value is predetermined with a chip operating frequency of 350 MHz that is sufficient in support of a stable operation of a mobile phone under a specific voltage of 1.2 V. Since the same-type chip can run at a maximum speed of up to 400 MHz for a personal computer, an actual operating speed value 1120 of the same-type chip applied for the mobile phone can be detected at 390 MHz, which is higher than the reference speed value (350 MHz) 1020 during the comparison. By utilizing the same invention concept as aforementioned, the operating speed value 1120 is successively lowered from 390 MHz to 350 MHz until the operating speed value 1120 approaches the reference speed value 1020. Due to difference of the reference speed values required between the frequency-driven voltage control and the foregoing process-driven voltage control, another power saving behavior adaptive for the same-type chips applied in different configurations can be selectively achieved.

For another exemplary of combination of a frequency-driven and process-driven voltage controls on the same-type and different-corner chips for different configurations, the reference speed value is predetermined with an operating frequency of 340 MHz, which is sufficient in support of stable operation of a sampled SS-corner chip applied in the mobile phone under the specific voltage supply of 1.2 V Since the SS-corner chip can run at a maximum speed of up to 400 MHz for a personal computer, an actual operating speed value 1120 of the same-type, different-corner (i.e. TT-corner) chip applied for the mobile phone may be detected at 390 MHz, which is higher than the reference speed value (340 MHz) 1020 during the comparison. By utilizing the same invention concept as aforementioned, the operating speed value 1120 is successively lowered from 390 MHz to 340 MHz until the operating speed value 1120 approaches the reference speed value 1020. Thus, another power saving behavior adaptive for the same-type and different-corner chips applied in the different configurations can be selectively achieved.

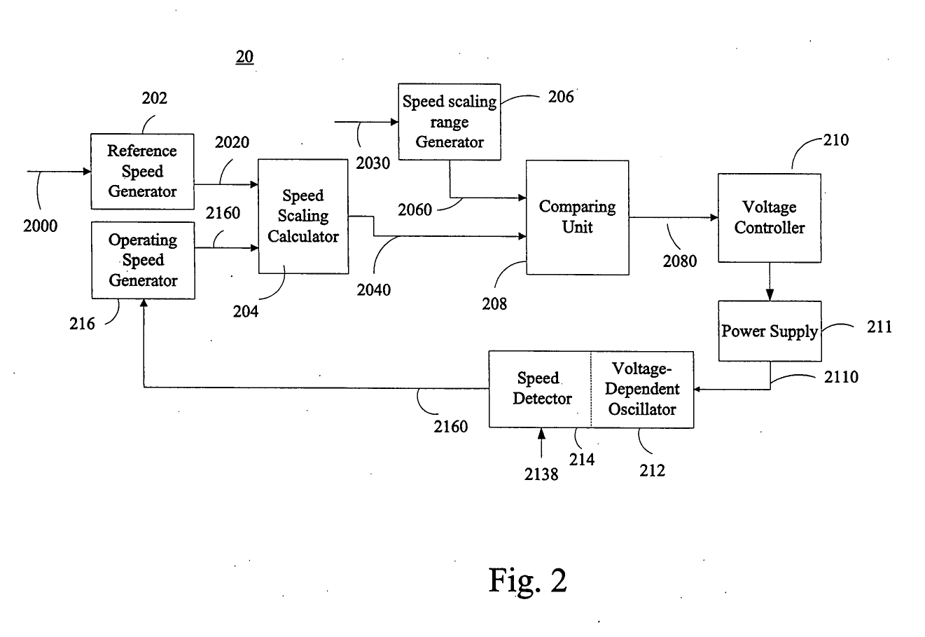

Further referring to a schematic architecture diagram of another speed adjustment system 20 illustrated in FIG. 2, according to a second preferred embodiment of the present invention. Differently from the first embodiment, the speed adjustment system 20 primarily includes a reference speed generator 202, a speed scaling calculator 204, a speed scaling range generator 206, a comparing unit 208, a voltage controller 210, a voltage-dependent oscillators unit 212, a speed detector 214, and an operating speed generator 216.

The reference speed generator 202 is configured as the same structure shown in FIG. 4, including a reference speed setting unit 2024 and a reference speed register 2026. The reference speed setting unit 2024 of the reference speed generator 202 receives a voltage setting signal 2000 to pre-store multiple different reference speed values on the reference speed register 2026. Then the reference speed register 2026 selectively output one of the reference speed values 2020 to the speed scaling calculator 204, corresponding to an operating speed value output from the operating speed generator 216.

The operating speed generator 216 having an operating speed register is operative to pre-store multiple different operating speed value, by way of detection of the speed detector 214, respectively generated from the selected ring oscillator (ROSC) sets of the electrical system, and then selectively outputs proper one of the operating speed values 2160 with regard to the selected reference speed value 2020 to the speed scaling calculator 204.

The speed scaling calculator 204 is operative to calculate a speed scaling value 2040 to the comparing unit 208, by scaling the operating speed value 2160 relative to the reference speed value 2020. For example, a speed scaling value of “110%” denotes that the operating speed of the operating chip is being faster than the predetermined reference speed (i.e. an operating frequency of the sampled SS-corner chip).

The speed scaling range generator 206 implemented as a software or a hardware (e.g. a register) provides the comparing unit 208 with proper one of multiple different speed scaling range parameter sets 2060 which are preset on the speed scaling range generator 206. The preset speed scaling range parameter sets 2060 are designed to contain different scaling conditions, for example, a scaling of 85%, a range scaling of 80%˜100%, or down to 95%, for usage of different configurations and/or different-corner chips. Thus these different scaling conditions will bring different adaptive power-saving behaviors to the different-corner operating chips applied for different configurations. The preset speed scaling range should be predetermined upon a control signal 2030 in response to some special functions (i.e., a power saving mode), a detected environment (i.e. a higher temperature), the user demands, the kinds of the electrical system, or the other factors influencing the power consumption.

The comparing unit 208 determines whether a predefined logical operational relationship is satisfied or not. For example, if the speed scaling value 2040 is “95% ” which is included within the preset speed scaling range of 80%˜100%, it means that the power supply of the operating chip has reached a power saving behavior adaptive for the system. Then the comparing unit 208 will enable the voltage controller 210 to keep the logic level of the operating voltage 2110 unchanged, output from the power supply 211 to the voltage-dependent oscillators unit 212. For another example, if the speed scaling value 2040 is “120%” in excess of the preset speed scaling range of “80%˜100%”, it means that power supply of the operating chip has caused a power waste than required by the system. Then the comparing unit 208 will enable the voltage controller 210 to reduce the logic level of the internal operating voltage 2110 output from the power supply 211, which is fed to the voltage-dependent oscillators unit 212. The voltage controller 210 may have the same configuration as shown in either FIG. 3A or FIG. 3B

Similarly to the first embodiment of FIG. 1, the voltage-dependent oscillators unit 212 depends upon the logic level of the varied operating voltage 2110 of the power supply 211 to output multiple operating frequencies generated from the selected ROSC sets disposed within the voltage-dependent oscillators unit 212. Further referring to FIG. 6, the speed detector 214 receives a calibrating clock signal 2138 having a standard working frequency thereby respectively detecting the operating frequencies from the selected ROSC sets of the voltage-dependent oscillators unit 212 to generate multiple different operating speed values 2160 for data pro-storage on the operating speed generator 216. During a successive loop of speed comparison and voltage supply modification, the predefined logical operational relationship would be satisfied eventually. Thus, a power saving behavior adaptive for the required condition variance of the operating chip can be selectively achieved.

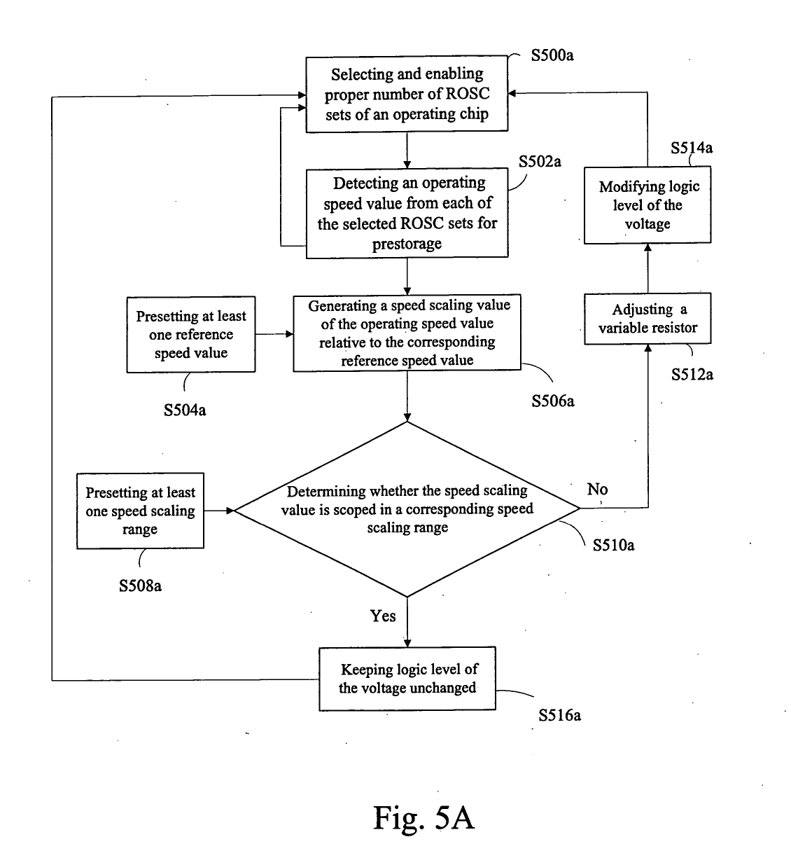

Referring to FIG. 5A, a method for adjusting an operating speed of an electrical system (e.g. an operating chip) shown in FIG. 2, during a normal operating mode, comprises the steps of:

Step S500a, selecting and enabling proper number of ring oscillator sets, based on an operating voltage supply or a core voltage of the operating chip;

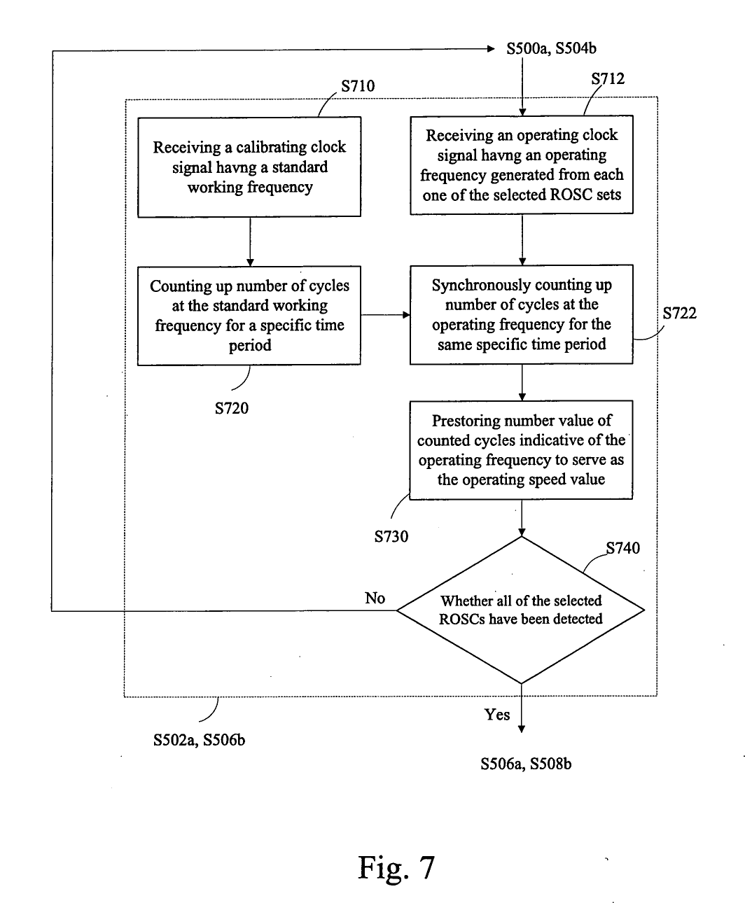

Step S502a, detecting an operating frequency generated from each of the selected ring oscillator sets based on operating voltage supply, to serve as a corresponding operating speed value to be pre-stored on an operating speed register (detailed as illustrated in FIG. 7) wherein the step of detecting the operating frequency, for example, further comprises a step of counting cycle number at the operating frequency for a specific time period;

Step S504a, programmably presetting multiple reference speed values to a reference speed register of an operating speed generator;

Step S506a, calculating a speed scaling value of the operating speed value relative to the corresponding reference speed value;

Step S508a, programmably presetting multiple speed scaling range parameters on a speed scaling range generator;

Step S510a, determining whether or not a predefined logical operational relationship that the speed scaling value is scoped within one of the corresponding speed scaling range parameters is satisfied; and

Step S516a, if the predefined logical operational relationship is satisfied, keeping the logic level of the operating voltage unchanged, and then returning to step S500a to continue to detect whether a change of the operating speed value occurs, thereby continuously monitoring the power consumption behavior of the operating chip; otherwise, performing the steps S512a and S514a to adjust a variable resistor of a voltage controller to vary the logic level of the operating voltage of the power supply, based on a difference from the speed comparison, and then returning to the step S500a in order to continuously lower the operating frequency and power consumption of the operating chip per cycle of the loop established from the step S500a to S516a until the predefined logical operational relationship is satisfied. A required power saving behavior adaptive for the operating chip will be therefore obtained.

Further referring to FIG. 5B, a method for adjusting an operating speed of an electrical system (e.g. an operating chip), in a booting mode, comprises the steps of:

Step S500b, initializating the operating chip to load several required configurations and settings;

Setp S502b, presetting multiple reference speed values on a reference frequency register of a reference frequency generator for pre-storage;

Step S504b, selecting and enabling proper number of ring oscillator sets of the operating chip, based on an operating voltage supply;

Step S506b, detecting a corresponding operating frequency generated from each of the selected ring oscillator sets, to serve as an operating speed value to be pre-stored on an operating speed register (detailed as illustrated in FIG. 7), wherein the step of detecting the operating frequency, for example, comprises a step of counting cycle number at the operating frequency for a specific time period;

Step S508b, outputting proper one of the operating speed values from the operating speed register;

Step S510b, determining whether the operating speed value is lower than one of the reference speed values, corresponding to the operating speed value. In another case, a speed determination of whether a speed scaling value of the operating speed value relative to the reference speed value is in a preset speed scaling range or not can be implemented as the steps 506a and 510a shown in FIG. 5A; and

Step S512b, if the operating speed value (i.e. 299 MHz) is lower than the reference speed value (i.e. 300 MHz), keeping the logic level of the operating voltage unchanged, and then ending; otherwise if the operating speed value (i.e. 350 MHz) is being faster than the reference speed value (i.e. 300 MHz) to result in a power waste behavior, performing the step S516b and S514b to adjust a variable resistor of a voltage controller to vary the logic level of the operating voltage, based on a speed difference from the speed comparison, and then returning to the step S504b for continuously lowering the operating frequency of the chip per cycle of a loop established from the step S504b to S510b, until the operating speed value is completely lower than the reference speed value. A required power saving behavior is therefore obtained.

Detailed in the step S502a of FIG. 5A or the step S506b of FIG. 5B, a method for detecting each operating frequency generated from each of the selected ring oscillator sets of an electrical system to serve as an operating speed value. A flow chart of the method as shown in FIG. 7 comprises the steps of:

Step S710, receiving a calibrating clock signal having a standard working frequency provided from an external device or other component;

Step S720, counting up number of cycles at the standard working frequency by a second counter for a specific time period;

Step S712, receiving an operating clock signal having an operating frequency generated from each one of the selected ROSC sets of the voltage-dependent oscillators unit;

Step S722, counting up number of cycles at the operating frequency by a first counter in synchronization with the beginning of counting up of the second counter for the same specific time period;

Step S730, pre-storing number value of counted cycles indicative of the operating frequency to serve as the operating speed value; and

Step S740, determining whether all of the selected ROSC sets have been detected; if so, going to the step S506a of FIG. 5A or the step S508b of FIG. 5B; and otherwise going to the step S500a of FIG. 5A or the step S504b of FIG. 5B.

Please note that the present invention can be implemented to adjust (rising or lowering) an adaptive power supply of an electrical system for different conditions, for example, a power saving (sleeping) mode for a non-operating period, a light power mode for application of a word-processing software or an user-reading period, or a high performance power consumption mode for supporting a 3D graphic engine, by way of predetermining multiple different speed scaling range values for said different conditions. Furthermore, the reference speed value and the operating speed value are not implemented only for limited in frequency value but can be implemented by other parameters under some conditions, like an operating temperatures on the operating chip and a preset reference temperature, or by other signals based on activation of some specific functions, like a huge/less image-data process. The speed scaling range value can be a specific range or a value (e.g. lower than a specified temperature value or a speed percentage), which can be reset during fabrication of the chip or reset by the user on demands.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for adjusting an operating speed of an electrical system, comprising the steps of:
(1a) Detecting at least one operating speed value generated relative to an operating voltage supplied to the electrical system;
(1b) Storing the operating speed value;
(1c) Determining whether a predefined logical operational relationship between the operating speed value and a reference speed value is satisfied;
(1d) Keeping logic level of the operating voltage unchanged if the predefined logical operational relationship is satisfied; and
(1e) Adjusting the logic level of the operating voltage until the predefined logical operational relationship is satisfied if the predefined logical operational relationship is unsatisfied, wherein the reference speed value is pre-stored.

2. The method as claimed in claim 1, wherein the electrical system is an integrated chip.

3. The method as claimed in claim 1 further comprising a step of pre-storing multiple different reference speed values on a reference speed register before performing the step (1a).

4. The method as claimed in claim 1 further comprising a step of detecting the operating speed value by using an operating frequency generated from a voltage-dependent oscillators unit of the electrical system depending upon the operating voltage.

5. The method as claimed in claim 4 wherein the voltage-dependent oscillators unit has multiple ring oscillator sets each which contains at least one ring oscillator therein.

6. The method as claimed in claim 5 further comprising the steps of:
(1f) Selecting a plurality of the ring oscillator sets;
(1g) Detecting multiple operating speed values from the selected ring oscillator sets responding to the operating voltage supplied to the electrical system; and
(1h) Pre-storing the operating speed values on an operating speed register.

7. The method as claimed in claim 6 further comprising a step of:
receiving a calibrating clock signal having a standard working frequency;
counting up number of cycles at the standard working frequency for a specific time period;
receiving an operating clock signal having an operating frequency generated from each one of the selected ring oscillator sets;
counting up number of cycles at the operating frequency in synchronization with the beginning of the counting at the standard working frequency for the same specific time period;
pre-storing number value of counted cycles indicative of the operating frequency to serve as the operating frequency value on an operating speed register;
determining whether each of the selected ring oscillator sets have been detected; and
if the selected ring oscillator sets have been detected, going to the step (1c), otherwise going to the step (1f).

8. The method as claimed in claim 1 wherein the predefined logical operational relationship defines that the operating speed value is either identical with or less than the reference speed value.

9. The method as claimed in claim 1 further comprising a step of:
pre-storing at least one speed scaling range on a speed scaling range register.

10. The method as claimed in claim 9 further comprising a step of: generating a speed scaling value of the operating speed value relative to the reference speed value prior to determine the predefined logical operational relationship.

11. The method as claimed in claim 10 wherein the predefined logical operational relationship defines that the speed scaling value of the operating speed value relative to the reference speed value is included within the pre-stored speed scaling range.

12. The method as claimed in claim 1 further comprising a step of:
if the predefined logical operational relationship is unsatisfied, adjusting the logic level of the operating voltage by changing resistance of a variable resistor; and returning to the step (1a).

13. The method as claimed in claim 1 further comprising a step of:
if the predefined logical operational relationship is satisfied, keeping the operating voltage unchanged at logic level; and returning to the step (1a).

14. A speed adjustment system for adjusting an operating speed of an electrical system, comprising:
a reference speed generator pre-storing at least one reference speed value thereon;
a speed detector detecting at least one operating speed value generated relative to an operating voltage supplied to the electrical system;
an operating speed generator pre-storing the operating speed value thereon;
a comparing unit determining whether a predefined logical operational relationship between the operating speed value and the reference speed value is satisfied; and
a voltage controller based on said determination result to determine which logic level of the operating voltage is fed to the speed detector.

15. The system as claimed in claim 14, wherein the electrical system is an integrated chip.

16. The system as claimed in claim 14 wherein the reference speed generator has a reference speed register for pre-storing multiple reference speed values thereon.

17. The system as claimed in claim 14 further comprising a voltage-dependent oscillator unit that includes multiple ring oscillator sets depending upon the logic level of the operating voltage to respectively emulate multiple operating frequencies.

18. The system as claimed in claim 17 wherein the speed detector detects the multiple operating frequencies to serve as the operating speed values and outputs the operating speed values to the operating speed generator for pre-storage.

19. The system as claimed in claim 18 wherein the speed detector has a first counter and a second counter wherein the second counter employs a calibrating clock signal at a standard working frequency to count up number of cycles for a specific time period, and the first counter employs the operating frequency generated from each one of the ring oscillator sets of the voltage-dependent oscillators unit to count up number of cycles in synchronization with the beginning of counting of the second counter for the same specific time period.

20. The system as claimed in claim 19 wherein the speed detector determines whether the ring oscillator sets have been detected.

21. The system as claimed in claim 18 wherein the operating speed generator has an operating speed register for pre-storing the multiple operating speed values thereon.

22. The system as claimed in claim 14 further comprising a speed scaling range generator for pre-storing multiple different speed scaling ranges.

23. The system as claimed in claim 14 further comprising a speed scaling calculator used for calculating a speed scaling value of the operating speed value relative to the reference speed value prior to determination of the predefined logical operational relationship.

24. The system as claimed in claim 23 wherein the comparing unit determines whether the predefined logical operational relationship that the speed scaling value of the operating speed value relative to the reference speed value is included within the preset speed scaling range is satisfied or not.

25. The system as claimed in claim 14 wherein the comparing unit determines whether the predefined logical operational relationship that the operating speed value is either identical with or less than the reference speed value is satisfied or not.

26. The system as claimed in claim 14 wherein if the predefined logical operational relationship is satisfied, the voltage controller keeps logic level of the operating voltage unchanged to be fed to the speed detector.

27. The system as claimed in claim 14 wherein if the predefined logical operational relationship is unsatisfied, the voltage controller adjusts the logic level of the operating voltage to be fed to the speed detector until the predefined logical operational relationship is satisfied.

28. The system as claimed in claim 14 wherein the voltage controller has a variable resistor for determining which logic level of the operating voltage.
